(19) United States
(12) Patent Application Publication
(10) Pub. No.: US 2019/0106659 A1
(43) Pub. Date: Apr. 11, 2019

(54) BEER-FLAVORED BEVERAGE PRODUCTION METHOD AND BEER-FLAVORED BEVERAGE

(71) Applicant: SAPPORO HOLDINGS LIMITED, Tokyo (JP)

(72) Inventors: Tetsuro SHINKAI, Shibuya-ku (JP); Yuta MATSUI, Shibuya-ku (JP)

(21) Appl. No.: 16/093,874

(22) PCT Filed: Feb. 1, 2017
(86) PCT No.: PCT/JP2017/003640

§ 371 Date: Oct. 15, 2018

(30) Foreign Application Priority Data
Apr. 26, 2016 (JP) 2016-088217

(51) Int. Cl. C12C 5/00; C12C 5/02; C12C 11/00; A23L 2/38; A23L 2/56

(52) U.S. Cl. CPC C12C 5/004; C12C 5/026; A23V 2002/00; A23L 2/382; A23L 2/56; C12C 11/003

(57) ABSTRACT

The present invention relates to a method of producing a beer-taste beverage, wherein the method comprises using a mugi material as a material, and adding glucoamylase and β-amylase in a fermentation process.

### TECHNICAL FIELD

The present invention relates to a method of producing a beer-taste beverage, and a beer-taste beverage.

### BACKGROUND ART

There is a growing demand for a beer-taste beverage having a reduced sugars content. The sugars content of a beer-taste beverage can be reduced by reducing the content of non-assimilable sugars in a fermentation solution in the production process, for example. The sugars content in a final product can be reduced by raising the proportion of materials, such as syrup, originally having a low content of non-assimilable sugars to be used as materials for fermentation. At a high proportion of materials such as syrup to be used, however, beer-taste beverages having a sufficiently good flavor cannot be obtained.

Patent Literature 1 discloses a production method comprising adding glucoamylase in the preparing process and/or the fermentation process, and adding transglucosidase in the fermentation process, as a method of reducing the amount of non-assimilable sugars in the fermentation solution if materials having a high content of non-assimilable sugars, such as cereal materials, are used as materials for fermentation. According to Patent Literature 1, by such a production method, most of polysaccharides, which determine the amount of sugars in final products, can be hydrolyzed into sugars assimilable by yeast, reducing the sugars content in final products even if a large amount of cereal materials such as malt is used as a material for fermentation.

### CITATION LIST

### Patent Literature

Patent Literature 1: WO 2014/196265

### SUMMARY OF INVENTION

### Technical Problem

However, conventional beer-taste beverages having a reduced sugars content are not considered to have a sufficiently good flavor and taste. For example, a beer-taste beverage described in Patent Literature 1 has a strong flavor of isoamyl acetate, and does not have a preferable flavor and taste.

An object of the present invention is to provide a beer-taste beverage having a reduced flavor of isoamyl acetate and a low sugars content, and a method of producing the same.

### Solution to Problem

A method of producing a beer-taste beverage according to the present invention comprises using a mugi material as a material, and adding glucoamylase and β-amylase in a fermentation process. A beer-taste beverage having a reduced flavor of isoamyl acetate and a low sugars content can be obtained using the production method.

It is preferable that the method of producing a beer-taste beverage above further comprise adding pullulanase in a fermentation process. Furthermore, it is preferable that the method of producing a beer-taste beverage above comprise adding a polysaccharide degrading enzyme in a preparing process. According to such a configuration, the sugars content of a beer-taste beverage can be more efficiently reduced and the flavor and taste of the beer-taste beverage can be more significantly improved.

The present invention also provides a beer-taste beverage wherein the proportion of a mugi material contained in a material is 50% by mass or higher, a sugars content in the beverage is less than 2.0 g/100 mL, and a concentration of isoamyl acetate in the beverage is 2 ppm or less. The beer-taste beverage has a reduced flavor of isoamyl acetate.

It is preferable that the beer-taste beverage above comprise ethyl acetate, and the mass ratio of the content of isoamyl acetate to the content of ethyl acetate be 0.060 or lower. At a mass ratio within the range above, the flavor of isoamyl acetate can be more significantly reduced and the flavor and taste in the beer-taste beverage can be more significantly improved.

It is preferable that the mugi material for the beer-taste beverage above comprise malt and barley, and the ratio of malt to barley be 20:80 to 100:0. At a ratio of malt to barley within the range above, the flavor and taste of the beer-taste beverage can be more improved.

It is preferable that an alcohol chill haze of the beer-taste beverage above be 0.2 or less.

In the beer-taste beverage above, it is preferable that a concentration of alcohol be 3% by volume or more.

### Advantageous Effects of Invention

The present invention can provide a beer-taste beverage having a reduced flavor of isoamyl acetate and a low sugars content.

### DESCRIPTION OF EMBODIMENTS

Embodiments of the present invention will be described in detail below. It should be noted that the present invention is not limited to the embodiments below.

The method of producing a beer-taste beverage according to the present invention comprises using a mugi material as a material, and adding glucoamylase and β-amylase in a fermentation process.

The term “beer-taste beverage” as used herein refers to a beverage having a taste and flavor similar to beer and giving a sense of drinking beer to a drinker when the drinker drinks the beverage. A beer-taste beverage may be an alcoholic beverage, or may be a non-alcoholic beverage. The term “non-alcoholic” indicates that substantially no alcohol is contained. The alcohol content of such a non-alcoholic beer-taste beverage may be less than 1% by volume, 0.5% by volume or less, 0.1% by volume or less, or less than 0.005% by volume, for example; or the non-alcoholic beer-taste beverage may not contain any alcohol at all. It should be noted that the term “alcohol” as used herein means ethanol unless otherwise indicated.

It is preferable that the beer-taste beverage be an alcoholic beverage. Examples of the alcoholic beer-taste beverage include those classified as beers, Happoushu, no malt beer, and liqueurs in Japanese Liquor Tax Act (Act No. 6, Feb. 28, 1953). It is preferable that the alcoholic beer-taste beverage be beer. The alcohol concentration of the alcoholic beer-taste beverage may be, for example, 1 to 30% by volume, 1 to 20% by volume, 3 to 20% by volume, 3 to 15% by volume, or 4 to 8% by volume.

The beer-taste beverage according to the present embodiment may be sparkling or non-sparkling. It is preferable that the beer-taste beverage according to the present embodiment be sparkling. The term “sparkling” as used herein indicates that the gas pressure at 20° C. is 0.049 MPa (0.5 kg/cm²) or higher, and the term “non-sparkling” indicates that the gas pressure at 20° C. is lower than 0.049 MPa (0.5 kg/cm²).

The term “mugi material” as used herein refers to mugi or mugi products. Mugi may be, for example, barley, wheat, rye, oat, or adlay and it is preferable that Mugi be barley. Examples of the mugi products include mugi extracts, malt, and malt extracts. The mugi extracts can be obtained by extracting mugi extraction components containing sugars and nitrogen from mugi. The malt can be obtained by germinating mugi. The malt extracts can be obtained by extracting extraction components containing sugars and nitrogen from the malt. A single mugi material may be used, or plural mugi materials may be used in combination. It is preferable that the mugi material comprise malt, and from the viewpoint of flavor, it is more preferable that the mugi material comprise barley malt. The method of producing a beer-taste beverage according to the present embodiment can produce a beer-taste beverage having a sufficiently reduced content of sugars even if a large amount of mugi material is used as a material.

The proportion of the mugi material in the materials may be 50% by mass or higher, 66% or higher, or 67% or higher; and it is preferable that the proportion be 70% by mass or higher; it is more preferable that the proportion be 80% by mass or higher; it is still more preferable that the proportion be 90% by mass or higher; it is further more preferable that the proportion be 95% by mass or higher; and it is particularly preferable that the proportion be 99% by mass or higher. The proportion of the mugi material in the materials may be 100% by mass. At a proportion of the mugi material in the materials within the range above, the flavor and taste of the beer-taste beverage can be more significantly improved. It should be noted that the term “materials” as used herein refer to materials excluding water and hops among all the materials used for the production of the beer-taste beverage.

It is preferable that the mugi material comprise malt and barley. The ratio of malt to barley may be, for example, 20:80 to 100:0; it is preferable that the ratio be 25:75 to 100:0; and it is more preferable that the ratio be 50:50 to 100:0. At a ratio of malt to barley within the range above, the flavor and taste of the beer-taste beverage can be more significantly improved.

The materials may contain materials other than the mugi material. The materials other than the mugi material may be, for example, plant materials including grains such as corn, rice, and kaoliang, potatoes such as white potatoes and sweet potatoes, and beans, or may be sugars materials such as starch, grits, and syrup.

The beer-taste beverage according to the present embodiment can be obtained by a production method comprising at least a preparing process and a fermentation process. The preparing process is a process to prepare a pre-fermentation solution to be used for fermentation. In the preparing process, the materials and water may be mixed; after mixed with water, the materials may be saccharified; or after the saccharification, the materials may be further filtered, boiled, precipitated, and cooled, for example.

In the fermentation process, the pre-fermentation solution prepared in the preparing process is fermented. In the method of producing a beer-taste beverage according to the present embodiment, glucoamylase and β-amylase are added in the fermentation process. In the method of producing a beer-taste beverage according to the present embodiment, addition of glucoamylase and β-amylase in the fermentation process can promote a reaction to hydrolyze sugars contained in the material into those that yeast can assimilate, and at the same time, can reduce the flavor of isoamyl acetate of the beer-taste beverage.

The glucoamylase to be used in the production method according to the present embodiment is also referred to as glucan 1,4-α-glucosidase, which is an exoenzyme that sequentially hydrolyzes α-1,4-glycosidic bonds in each glucose units from non-reducing terminals of amylose and amylopectin. Furthermore, generally glucoamylase also hydrolyzes α-1,6 bonds present in amylopectin.

The β-amylase to be used in the production method according to the present embodiment is an exoenzyme that sequentially hydrolyzes α-1,4-glycosidic bonds in each maltose units from non-reducing terminals of amylose and amylopectin.

In the production method according to the present embodiment, pullulanase may further be added in the fermentation process. Pullulanase is an endoenzyme that cleaves the α-1,6-glycosidic bonds of amylopectin, dextrin, and pullulan, for example. Addition of pullulanase in the fermentation process may more efficiently reduce the content of sugars in the beer-taste beverage, and may improve the flavor and taste of the beverage. In the fermentation process, enzymes, such as another polysaccharide degrading enzyme and proteases, may further be added.

Enzymes such as β-amylase may be contained in plant materials themselves such as mugi plants, beans, and potatoes; however, in the production method according to the present embodiment, each of the enzymes above is separately added as an external enzyme besides the plant materials or the sugars materials as the materials.

The amounts of the enzymes above to be added can be appropriately adjusted according to the types of enzymes to be used and their activity, and the types of materials, for example. The amount of glucoamylase to be added may be 0.001 to 2% w/v, 0.01 to 1% w/v, or 0.1 to 0.5% w/v relative to the amount of a cooled wort, for example. Alternatively, the amount of the glucoamylase to be added may be 2.50 to 5000 U/mL, 25 to 2500 U/mL, or 250 to 1250 U/mL relative to the amount of the cooled wort, for example. The amount of β-amylase to be added may be 0.001 to 2% w/v, 0.01 to 1% w/v, or 0.1 to 0.5% w/v relative to the amount of the cooled wort, for example. Alternatively, the amount of the β-amylase to be added may be 0.017 to 34 U/mL, 0.17 to 17 U/mL, or 1.7 to 8.5 U/mL relative to the amount of the cooled wort, for example. The amount of pullulanase to be added may be 0.001 to 2% w/v, 0.01 to 1% w/v, or 0.05 to 0.2% w/v relative to the amount of the cooled wort, for example. Alternatively, the amount of the pullulanase to be added may be 0.03 to 60 U/mL, 0.3 to 30 U/mL, or 1.5 to 6 U/mL relative to the amount of the cooled wort, for example.

The glucoamylase and β-amylase may be added such that the glucoamylase and β-amylase having hydrolysis activity are present in the fermentation solution at any time point from the beginning to the end of the fermentation process. Each enzyme may be added to the pre-fermentation solution at the beginning of the fermentation process or may be added during the fermentation. The enzymes may be added in batch at one time, or aliquots thereof may be added several times. It is preferable that the enzymes be added at an earlier stage of the fermentation process to increase the time where the enzymes act on the materials and to perform sufficient hydrolysis reactions. Several enzymes may be added in batch at one time, or each may be added separately in any order. In a case where pullulanase and other enzymes are used optionally, embodiments similar to that of the addition of glucoamylase or β-amylase are also applicable to the addition of pullulanase.

The method of producing a beer-taste beverage according to the present embodiment can employ a method similar to a known method of producing a beer-taste beverage where fermentation is involved, except that the enzymes are used as above. In the fermentation process, yeast is added to perform alcoholic fermentation. As the temperature of fermentation by yeast, a temperature of fermentation for conventional beer-taste beverages can be used if the temperature is within the range where the enzymes to be added can exhibit a hydrolysis action; the temperature may be 0 to 40° C., for example. The time of fermentation can be appropriately adjusted according to the desired properties of the beer-taste beverage. In the fermentation process, aging may be further performed. The aging can be performed by further maintaining the fermentation solution after the fermentation at a predetermined temperature for a predetermined time. By performing the aging, unnecessary substances in the fermentation solution can be deposited to remove turbidity, improving the flavor and taste of the beer-taste beverage.

A post-fermentation solution that contains alcohol generated by the yeast and other substances can be obtained through the fermentation process. The alcohol concentration (alcohol by volume) of the post-fermentation solution may be, for example, 1 to 20% by volume, 1 to 10% by volume, or 3 to 10% by volume. In a case where the target alcohol concentration is less than 1% by volume, the alcohol concentration can be reduced by appropriately adjusting the conditions for the fermentation, for example, by decreasing the time of fermentation and lowering the temperature of fermentation in the fermentation process. In addition, a post-fermentation solution containing 1 to 20% by volume of alcohol can be appropriately diluted to achieve the alcohol concentration of less than 1% by volume.

The post-fermentation solution may undergo a predetermined process as a post-fermentation process after the fermentation process to finally obtain the beer-taste beverage. Examples of the post-fermentation process include filtration (corresponding to so-called primary filtration) of the post-fermentation solution obtained in the fermentation process. By the primary filtration, insoluble solid contents and yeast can be removed from the post-fermentation solution. Furthermore, in the post-fermentation process, microfiltration (also referred to as secondary filtration) of the post-fermentation solution may be further performed. By the secondary filtration, various genus and residual yeast can be removed from the post-fermentation solution. It should be noted that the post-fermentation solution can be pasteurized through heating in place of the microfiltration. In the post-fermentation process, the primary filtration, the secondary filtration, and the heating can be performed with general equipment used for producing a beer-taste beverage.

Hops may be used as a material in the production of the above mentioned beer-taste beverage. The use of hops can impart a beer-like flavor to the beer-taste beverage. Hops can be used in the form of hop pellets or hop extracts, for example. The hops may be hop products such as rho hop, hexa hop, tetra hop, and isomerized hop extracts. The hops and the like may be added in any of the preparing process, the fermentation process, and the post-fermentation process, and may be added several times. In a case where filtration and boiling are performed in the preparing process, it is preferable that the hops be added before the filtration and the boiling. Examples of methods of adding the hops include, but should not be limited to, kettle hopping, late hopping, and dry hopping. The term “kettle hopping” indicates that the hops are fed during the heating of the pre-fermentation solution or at an early stage of the boiling, and the term “late hopping” indicates that the hops are fed immediately before the end of the boiling. The term “dry hopping” indicates that the hops are fed after the start of the fermentation process. The hop products may be rho hop, hexa hop, tetra hop, or isomerized hop extracts, for example.

In a case where it is desired to increase the alcohol concentration of the post-fermentation solution, alcohol such as spirit may be added in the post-fermentation process. The post-fermentation process also comprises a process of filling the beer-taste beverage into containers such as bottles and cans. In a case where the produced beer-taste beverage is non-sparkling or insufficiently sparkling, addition of carbonated water or carbonation may be performed to carbonate the beer-taste beverage to a desired extent.

In the production method according to the present embodiment, it is preferable that an enzyme be added in the preparing process. The enzyme to be added in the preparing process may be a polysaccharide degrading enzyme or a protease, for example, and it is preferable that the enzyme be a polysaccharide degrading enzyme. The polysaccharide degrading enzyme to be added in the preparing process may be a single polysaccharide degrading enzyme and it is preferable that the polysaccharide degrading enzyme be several different polysaccharide degrading enzymes. By adding the polysaccharide degrading enzyme in the preparing process, the content of sugars in the beer-taste beverage can be more effectively reduced. It should be noted that in a case where the boiling is performed in the preparing process, it is preferable that the timing to add the enzyme be before the boiling to allow the enzyme to act sufficiently.

Glucoamylase, β-amylase, pullulanase, and other enzymes to be added in the fermentation process may also be added in both the fermentation process and the preparing process. The glucoamylase, β-amylase, pullulanase, and other enzymes to be added in the fermentation process have an effect to reduce sugars even if these enzymes are added only in the preparing process; however, a more significant effect to reduce sugars can be obtained when these enzymes are added in the fermentation process.

In the present embodiment, alcohols may be further added as required in addition to the alcohol obtained by fermenting the materials. The alcohols to be added may be any alcohol for drinking, and their types, production methods, and materials are not limited. For example, one of spirits such as Japanese spirit Shochu, brandy, and vodka, and alcohols for materials can be added, or two or more thereof can be added in combination. In addition, in a case where the concentration of the alcohol obtained by fermenting the materials is high, dilution may be performed as required to a desired concentration.

A beer-taste beverage having a reduced flavor of isoamyl acetate and a low sugars content can be obtained by the above mentioned method of producing a beer-taste beverage. Therefore, the above mentioned method can also be referred to as a method of reducing an flavor of isoamyl acetate in a beer-taste beverage.

The present invention also provides a beer-taste beverage having a sugars content of less than 2.0 g/100 mL, and a concentration of isoamyl acetate of 2 ppm or less. The beer-taste beverage has a reduced flavor of isoamyl acetate. The beer-taste beverage can be obtained through the above mentioned method of producing a beer-taste beverage, for example.

The term “sugars” as used herein refers to sugars according to the Nutrition Labeling Standards for food products (Ministry of Health, Labour and Welfare Notification No. 176, 2003). Specifically, sugars means the residues of a food product after proteins, lipids, dietary fibers, ash, water, and alcohol are removed. In addition, the amount of sugars in a food product is calculated by subtracting the amounts of proteins, lipids, dietary fibers, ash, water, and alcohol from the weight of the food product. The amounts of proteins, lipids, ash, and water are measured by the methods set forth in the Nutrition Labeling Standards of Japan. The amount of alcohol can be measured along with the amount of water. Specifically, the amount of proteins is measured by a method of quantitating the total nitrogen (proteins) using the Improved Dumas method; the amount of lipids is measured by the ether extraction method, the chloroform/methanol mixed liquid extraction method, the Gerber method, the acid decomposition method, or the Roese-Gottlieb method; the amount of ash is measured by the magnesium acetate addition asking method, the direct asking method or the sulfuric acid addition ashing method; and the amounts of water and alcohol are measured by the Karl-Fischer method, the drying aid method, the drying method by heating under reduced pressure, the drying method by heating under atmospheric pressure, or the plastic film method.

Except for a case where dietary fibers are separately added, it is believed that the content of dietary fibers contained in a beer-taste beverage is derived from the materials such as the mugi. It is known that the content of dietary fibers contained in the beer-taste beverage obtained by the production method according to the present embodiment is usually 0.1 g/100 mL or lower. Therefore, in the present specification, the content of sugars is calculated, considering that the content of dietary fibers in the beer-taste beverage is 0.1 g/100 mL. It is preferable that, in the beer-taste beverage according to the present embodiment, the content of dietary fibers derived from the mugi material be 0.1 g/100 mL or less. The amount of dietary fibers is measured by high-performance liquid chromatography or the Prosky method. Dietary fibers besides those derived from plant materials such as the mugi material may be separately added to the beer-taste beverage. In such a case where dietary fibers are separately added, the content of sugars is calculated where a value obtained by adding the content of the added dietary fibers to 0.1 g/100 mL is defined as the content of dietary fibers contained in the beer-taste beverage.

The sugars content in the beer-taste beverage above may be less than 1.5 g/100 mL, or less than 1.0 g/100 mL; or the beer-taste beverage may be “sugars-free” which means that the sugars content is less than 0.5 g/100 mL according to the Nutrition Labeling Standards. The sugars content of the beer-taste beverage may be 0.5 g/100 mL or more, or 1.0 g/100 mL or more. The sugars content can be adjusted by the amounts of enzymes to be added in the preparing process and/or the fermentation process and the types of materials and their amounts to be used, for example.

The mass ratio of the content of sugars to the content of alcohol in the beer-taste beverage above may be 0.4 or lower, 0.3 or lower, 0.2 or lower, or 0.1 or lower, for example.

It is preferable that the concentration of isoamyl acetate of the beer-taste beverage above be lower than 1.5 ppm, and it is more preferable that the concentration be lower than 1.0 ppm. The flavor of isoamyl acetate in a beer-taste beverage does not always depend on the concentration of isoamyl acetate in the beer-taste beverage alone as described in Examples below; however, at a low concentration of isoamyl acetate in the beer-taste beverage, the flavor of isoamyl acetate in the beer-taste beverage can be more significantly reduced.

The mass ratio of a content of isoamyl acetate to alcohol in the beer-taste beverage above may be 0.00004 or lower, 0.00003 or lower, 0.00002 or lower, or 0.00001 or lower, for example.

It is preferable that the mass ratio of the content of isoamyl acetate to that of ethyl acetate in the beer-taste beverage above be 0.060 or lower, and it is more preferable that the mass ratio be 0.055 or lower. At a ratio of the concentration of isoamyl acetate to that of ethyl acetate of the beer-taste beverage within the range above, the flavor of isoamyl acetate can be more surely reduced.

The beer-taste beverage may contain coloring agents, fruit juice, antioxidants, flavoring agents, salts, acidulants, and minerals, for example.

The beer-taste beverage above has excellent haze stability. It is believed that the haze stability can be assessed using an alcohol chill haze as an index, and a lower value of alcohol chill haze can be assessed as a higher haze stability (Alcohol Chill Haze in Beer (Test Chapon), Analytica EBC, 9.41). The alcohol chill haze is determined by adding ethanol to a sample of a beer-taste beverage, cooling the sample to generate chill haze (turbidity generated by cooling), and measuring the turbidity of the sample. The alcohol chill haze is measured based on the above mentioned method of Analytica EBC. It is preferable that the alcohol chill haze of the beer-taste beverage above be 0.2 or less, it is more preferable that the alcohol chill haze be 0.18 or less, and it is still more preferable that the alcohol chill haze be 0.15. It is desirable that the alcohol chill haze be measured within 48 hours after the primary filtration. It is more desirable that the alcohol chill haze be measured within 24 hours after the primary filtration, and it is still more desirable that the alcohol chill haze be measured within 12 hours, within 6 hours, within 3 hours, or within 1 hour after the primary filtration.

The beer-taste beverage according to the present embodiment may be in a state that is filled in containers. Any known container for a beer-taste beverage can be used, and examples of the containers include cans, bottles, plastic containers such as plastic bottles, paper containers, pouch containers, and barrels.

### EXAMPLES

The present invention will be specifically described below by way of Examples. It should be noted that the present invention is not limited to Examples below.

### Example 1

Materials containing 17 kg of pulverized barley malt as a mugi material, 68 L of water for preparation, approximately 1.3% w/w of polysaccharide degrading enzyme relative to the barley malt were placed into a preparation tank to produce a saccharified solution according to a conventional method. The resulting saccharified solution was filtered to obtain a wort. Hops were added to the wort, and the wort was boiled; precipitates were separated and removed, and the wort was then cooled. 0.15% w/v (375 U/mL) of glucoamylase, 0.15% w/v (2.55 U/mL) of β-amylase, and 0.08% w/v (2.40 U/mL) of pullulanase relative to the amount of the cooled wort were added to the resulting pre-fermentation solution (cooled wort). Beer yeast was inoculated into the wort, and the wort was fermented for a predetermined period to obtain a beer-taste beverage having an alcohol concentration of approximately 5% by volume.

In Comparative Example 1, a beer-taste beverage was produced under the same condition as that in Example 1 except that β-amylase, glucoamylase, and pullulanase were not added but 0.15% w/v of transglucosidase was added in the fermentation. In Comparative Example 4, a beer-taste beverage was produced under the same condition as that in Example 1 except that none of the enzymes was added in the fermentation.

In Example 2 and Comparative Examples 2 and 5, beer-taste beverages were produced under the same conditions as those in Example 1 and Comparative Examples 1 and 4, respectively, except that the proportion of malt used in the materials was approximately 50% by mass (the balance was barley) and the amount of the polysaccharide degrading enzyme added in the preparing process was approximately 2.65% w/w relative to barley. In Example 3 and Comparative Examples 3 and 6, beer-taste beverages were produced under the same conditions as those in Example 1 and Comparative Examples 1 and 4, respectively, except that the proportion of malt used in the materials was approximately 25% by mass (the balance was barley) and the amount of the polysaccharide degrading enzyme added in the preparing process was approximately 2.65% w/w relative to barley.

(Content of Sugars)

The amounts of water, alcohol, proteins, and ash in the resulting beer-taste beverage were each measured. The contents of water and alcohol were measured by the drying method by heating under atmospheric pressure. The amount of proteins was measured by the method of quantitating the total nitrogen (proteins) using the Improved Dumas method. The amount of ash was measured by the direct ashing method. Considering that the content of lipids was 0 g/100 mL and the content of dietary fibers was 0.1 g/100 mL in the beer-taste beverage, the content of sugars (g/100 mL) of the beer-taste beverage was calculated as a value determined by subtracting the contents of water, alcohol, proteins, and ash, and 0.1 g/100 mL from the weight of the beer-taste beverage.

(Ethyl Acetate and Isoamyl Acetate)

The concentrations of ethyl acetate and isoamyl acetate in the beer-taste beverages were measured using a gas chromatograph equipped with an FID detector (Agilent 6890 Gas Chromatograph, manufactured by Agilent Technologies, LTD.) according to the method in “8.22 Low boiling aroma component” of the BCOJ Beer Analysis Methods. In addition, the ratio of the concentration of isoamyl acetate to that of ethyl acetate was calculated.

(Alcohol Chill Haze)

The alcohol chill haze in the beer-taste beverage was measured according to the following procedure.

A 200 mL sample and 6 mL of ethanol were put into a cuvette with a cap, and the cuvette was capped tightly; the sample and ethanol were then mixed. The cuvette containing the mixed sample was immediately immersed in a thermostatic water bath at −5° C., and was immersion-cooled for 60 minutes. The cuvette was taken out of the thermostatic water bath to measure the 90° scattered light turbidity with a turbidity meter.

(Sensory Evaluation)

Sensory evaluation was performed on the flavor and taste of the resulting beer-taste beverages by an expertized panel. Specifically, the sensory test for the flavor and taste was performed on the items of the flavor of isoamyl acetate, the sharpness and the smoothness during drinking, each on a five-grade scale of 1 to 5. A higher value for the flavor of isoamyl acetate indicates that the smell is less sensed. The term “sharpness” refers to a sense that an aftertaste does not last in the mouth, and a higher value for sharpness indicates that the stronger sharpness is sensed. The term “smoothness” indicates that a rough taste, and/or an astringent taste is not sensed on the tongue, and a higher value for smoothness indicates that more significant smoothness is sensed.

TABLE 1

| | | | | | Compar- | Compar- | Compar- | Compar- | Compar- | Compar- |
|---|---|---|---|---|---|---|---|---|---|---|
| | | | | | ative | ative | ative | ative | ative | ative |
| | | Exam- | Exam- | Exam- | Exam- | Exam- | Exam- | Exam- | Exam- | Exam- |
| | | ple 1 | ple 2 | ple 3 | ple 1 | ple 2 | ple 3 | ple 4 | ple 5 | ple 6 |
| Proportion of malt (% by mass) | | 100 | About | About | 100 | About | About | 100 | About | About |
| | | | 50 | 25 | | 50 | 25 | | 50 | 25 |
| Enzymes | β-amylase | 0.15 | 0.15 | 0.15 | — | — | — | — | — | — |
| added in | Glucoamylase | 0.15 | 0.15 | 0.15 | — | — | — | — | — | — |
| fermentation | Pullulanase | 0.08 | 0.08 | 0.08 | — | — | — | — | — | — |
| (w/v %) | Transglucosidase | — | — | — | 0.15 | 0.15 | 0.15 | — | — | — |
| Enzyme added in preparing | | About | About | About | About | About | About | About | About | About |
| process (w/w %) | | 1.33 | 2.65 | 2.65 | 1.33 | 2.65 | 2.65 | 1.33 | 2.65 | 2.65 |
| Protein (g/100 ml) | | 0.58 | 0.43 | 0.35 | 0.49 | 0.34 | 0.28 | 0.44 | 0.31 | 0.24 |
| Ash (g/100 ml) | | 0.15 | 0.15 | 0.16 | 0.16 | 0.16 | 0.18 | 0.14 | 0.15 | 0.17 |
| Sugars (g/100 ml) | | 0.68 | 0.59 | 0.60 | 0.61 | 0.64 | 0.69 | 0.92 | 1.02 | 1.15 |
| Isoamyl acetate (ppm) | | 1.8 | 1.1 | 1.8 | 2.2 | 2.4 | 2.7 | 3.4 | 3.3 | 3.2 |
| Ethyl acetate (ppm) | | 36.8 | 31.6 | 35.5 | 31.1 | 36.8 | 38.6 | 36.4 | 34.7 | 27.5 |
| Isoamyl acetate/Ethyl acetate | | 0.049 | 0.035 | 0.051 | 0.071 | 0.065 | 0.070 | 0.093 | 0.095 | 0.116 |
| Alcohol chill haze | | 0.14 | 0.115 | 0.09 | 0.255 | 0.29 | 0.355 | 0.585 | 0.28 | 0.31 |
| Sensory | Flavor of isoamyl | 4.5 | 4 | 3.7 | 2.3 | 2.7 | 1.8 | — | — | — |
| evaluation | acetate | | | | | | | | | |
| | Smoothness | 4.8 | 4 | 3.5 | 2.8 | 2.7 | 2.3 | — | — | — |
| | Sharpness | 4.5 | 4 | 3.3 | 2.8 | 2.5 | 2 | — | — | — |

Compared to Comparative Examples 1 to 3 where only transglucosidase was used as the enzyme to be added at the fermentation, the resulting beer-taste beverages in Examples 1 to 3 had a reduced flavor of isoamyl acetate, and excellent smoothness and sharpness during drinking. In addition, the beer-taste beverages in Examples 1 to 3 exhibited lower values of alcohol chill haze and excellent haze stability. Among Examples 1 to 3, a beer-taste beverage with a higher proportion of malt used in the material had a better result in the sensory evaluation.

Beer-taste beverages having the concentrations shown in Table 2 below by adding isoamyl acetate to each of the beer-taste beverages obtained in Examples 1 to 3 were used as Examples 4 to 6, respectively, and these beer-taste beverages in Examples 4 to 6 were evaluated in the same manner as described above. The results are shown in Table 2.

TABLE 2

| | | Example 4 | Example 5 | Example 6 |
|---|---|---|---|---|
| Isoamyl acetate (ppm) | | 2 | 1.9 | 2 |
| Ethyl acetate (ppm) | | 36.8 | 31.6 | 35.5 |
| Isoamyl acetate/Ethyl acetate | | 0.054 | 0.060 | 0.056 |
| Alcohol chill haze | | 0.14 | 0.115 | 0.09 |
| Sensory | Flavor of isoamyl acetate | 3.3 | 3.2 | 2.8 |
| evaluation | Smoothness | 4.2 | 3.5 | 3.0 |
| | Sharpness | 4.2 | 3.3 | 2.7 |

The beer-taste beverages with the increased concentrations of isoamyl acetate close to 2 ppm had a stronger flavor of isoamyl acetate compared to those without isoamyl acetate added; however, it was confirmed that the results of the sensory evaluation of the beverages with the increased concentrations of isoamyl acetate fell within the acceptable range.

1. A method of producing a beer-taste beverage, the method comprising:
preparing a pre-fermentation solution with a mugi material as a material; and
adding glucoamylase and β-amylase to the pre-fermentation solution in a fermentation process.

2. The method of claim 1, further comprising:
adding pullulanase to the pre-fermentation solution in the fermentation process.

3. The method of claim 1, wherein the preparing comprises preparing the pre-fermentation solution in a presence of a polysaccharide degrading enzyme.

4. A beer-taste beverage, comprising:
a mugi material as a material and
isoamyl acetate,
wherein a proportion of the mugi material in the material is 50% by mass or higher, a sugars content in the beer-taste beverage is less than 2.0 g/100 mL, and a concentration of the isoamyl acetate in the beer-taste beverage is 2 ppm or less.

5. The beer-taste beverage of claim 4, wherein the beer-taste beverage further comprises ethyl acetate, and
a mass ratio of a content of the isoamyl acetate to a content of the ethyl acetate is 0.060 or lower.

6. The beer-taste beverage of claim 4, wherein the mugi material comprises malt and barley, and a ratio of the malt to the barley is from 20:80 to 100:0.

7. The beer-taste beverage according to claim 4, wherein an alcohol chill haze is 0.2 or less.

8. The beer-taste beverage according to claim 4, wherein a concentration of alcohol is 3% by volume or more.

9. The method of claim 1, wherein a proportion of the mugi material in the material is 50% by mass or higher.

10. The method of claim 1, wherein the mugi material is malt, or malt and barley, and
when the mugi material is the malt and the barley, a ratio of the malt to the barley is from 50:50 to 100:0.

11. The method of claim 1, wherein an amount of the glucoamylase to be added is from 2.50 to 5000 U/mL and an amount of the β-amylase to be added is from 0.017 to 34 U/mL relative to an amount of a cooled wort.

12. The method of claim 2, wherein an amount of the pullulanase to be added is from 0.03 to 60 U/mL relative to an amount of a cooled wort.
